(19) United States
(12) Patent Application Publication
(10) Pub. No.: US 2016/0176238 A1
(43) Pub. Date: Jun. 23, 2016

(54) AIRCRAFT TIRE WITH CONCAVE SIDEWALL

(71) Applicant: The Goodyear Tire & Rubber Company, Akron, OH (US)

(72) Inventor: Kiyoshi Ueyoko, Copley, OH (US)

(21) Appl. No.: 14/579,128

(22) Filed: Dec. 22, 2014

(51) Int. Cl. B60C 13/00; B60C 9/18; B60C 9/02

(52) U.S. Cl. CPC B60C 13/003; B60C 9/02; B60C 9/18

(57) ABSTRACT

A pneumatic tire in accordance with the present invention includes two annular bead portions, a carcass, and a belt reinforcement layer. The carcass extends between the bead portions through sidewall portions and a tread portion. Each sidewall has an upper sidewall and a lower sidewall separated by the maximum width of the tire, wherein the lower sidewall further includes a first concave portion located between a radially outward end of the apex and the point of maximum width.

### FIELD OF THE INVENTION

This invention relates to pneumatic tires having a carcass and a belt reinforcing structure, more particularly to high speed heavy load tires such as those used on aircraft.

### BACKGROUND OF THE INVENTION

The radial carcass reinforcements of aircraft tires generally comprise several plies of textile cords, which are anchored to at least one annular bead member. A first group of reinforcing plies are generally wound around said annular bead member from the inside to the outside, forming turn-ups, the respective ends of which are radially spaced from the axis of rotation of the tire. The second group of plies are generally wound around the annular bead member from the outside to the inside of the tire.

Aircraft tires typically use numerous layers of ply which can significantly contribute to the tire weight. The numerous layers of ply may result in bead durability issues. It is thus desired to provide a lightweight efficient tire structure having improved bead durability. It is a further desired to provide an improved bead structure wherein the use of inside turn-up plies and outside turndown plies and their respective locations are optimized. Thus an improved aircraft tire is needed, which is capable of meeting high speed, high load and with reduced weight.

### SUMMARY OF THE INVENTION

A pneumatic tire in accordance with the present invention includes two annular bead portions, a carcass, and a belt reinforcement layer. The pneumatic tire further includes sidewalls, wherein each sidewall has an upper sidewall portion and a lower sidewall portion separated by the maximum width, wherein the lower sidewall portion further includes a first concave portion located between a radially outward end of the apex and the point of maximum width. The pneumatic tire may additionally comprise a second concave portion located in the upper sidewall.

### DEFINITIONS

“100 percent Modulus” means the force in mega-pascals (MPa) required to produce 100 percent elongation (e.g., stretch to two times original length).

“300 percent Modulus” or “M300 modulus” means the force in mega-pascals (MPa) required to produce 300 percent elongation (e.g., stretch to four times original length).

“Apex” means an elastomeric filler located radially above the bead core and between the plies and the turnup ply or axially outside the turnup ply.

“Annular” means formed like a ring.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread (e.g., the whole tire).

“Chafer” refers to a narrow strip of material placed around the exterior of the bead to protect bead structures from the rim, distribute flexing radially above the rim, and to better seal the tire to the rim.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“Inner” means toward the inside of the tire and “outer” means toward its exterior.

“Innerliner” means the layer or layers of elastomer or other material that form the inside surface of a tubeless tire and that contain the inflating fluid within the tire.

“Lateral” means an axial direction.

“Load Range” means load and inflation limits for a given tire used in a specific type of service as defined by tables in The Tire and Rim Association, Inc.

“Normal Load” means the specific design inflation pressure and load assigned by the appropriate standards organization for the service condition for the tire.

“Ply” means a cord-reinforced layer of rubber-coated radially deployed or otherwise parallel cords.

“Radial” and “radially” are used to mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which at least one ply has cords which extend from bead to bead are laid at cord angles between 65° and 90° with respect to the equatorial plane of the tire.

“Section Height” means the radial distance from the nominal rim diameter to the outer diameter of the tire at its equatorial plane.

“Section Width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

### BRIEF DESCRIPTION OF THE DRAWINGS

The present invention will be described by way of example and with reference to the accompanying drawing, in which:

FIG. 1 is an example schematic partial cross-sectional view of one half of a tire construction in accordance with the present invention.

FIG. 2 is an example schematic partial cross-sectional view of a bead structure in accordance with the present invention.

FIG. 3 is an example schematic showing the sidewall and bead area contours.

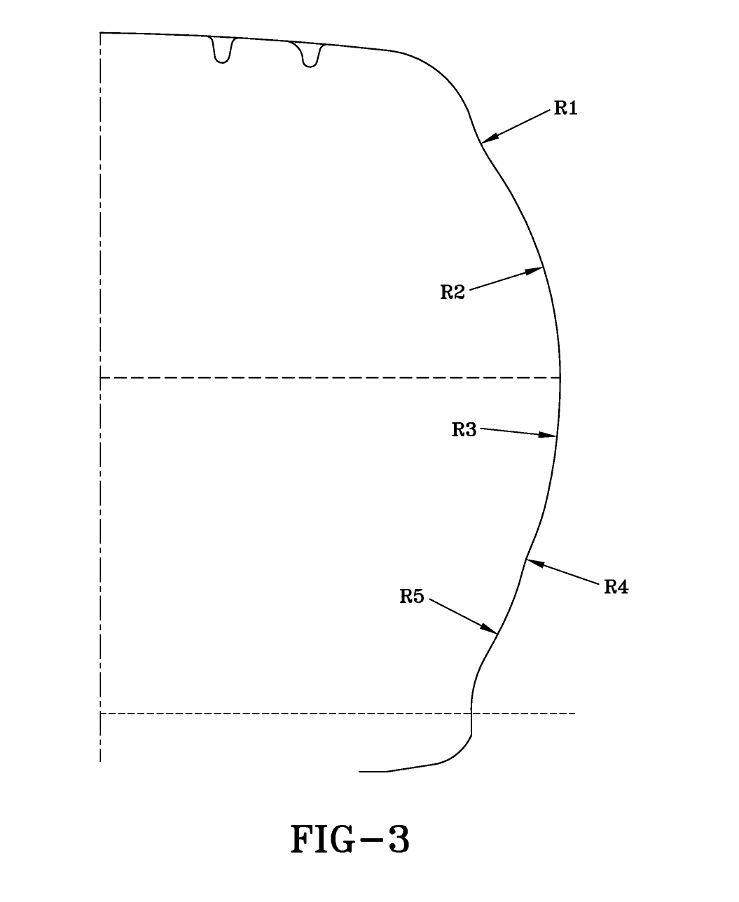

### DETAILED DESCRIPTION OF AN EXAMPLE OF THE PRESENT INVENTION

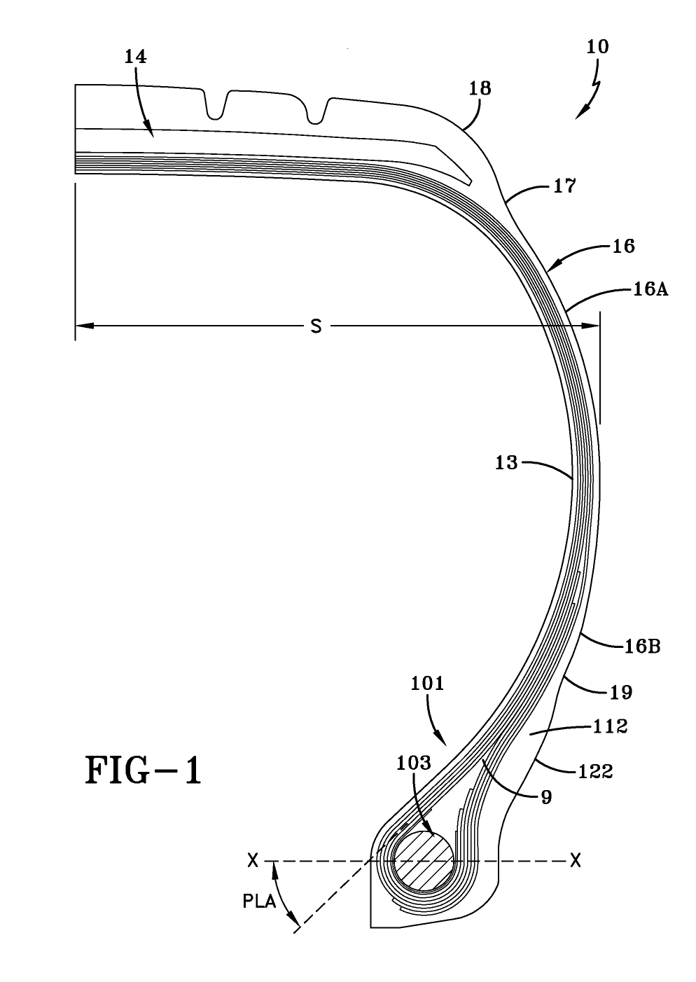

FIG. 1 illustrates a cross-sectional view of one half of a radial aircraft tire 100 of the present invention. The tire is symmetrical about the mid-circumferential plane so that only one half is illustrated. As shown, the aircraft tire comprises a pair of bead portions 101 each containing an annular bead member 103 embedded therein. One example of an annular bead member suitable for use in an aircraft tire is shown in U.S. Pat. No. 6,571,847. The annular bead member 103 preferably has an aluminum, aluminum alloy or other light weight alloy in the center portion surrounded by a plurality of steel sheath wires. A person skilled in the art may appreciate that other annular bead members may also be utilized.

The aircraft tire further comprises a sidewall 16 extending substantially outward from each of the bead portions 101 in the radial direction of the tire, and a tread 14 extending between the radially outer ends of the sidewall portions 16. At the outer axial edges of the tread, a shoulder 18 joins together the sidewall 16 and the tread 14. The shoulder 18 has a radius Rs. Preferably, the sidewall 16 has an upper sidewall 16a and a lower sidewall portion 16b. The upper sidewall portion 16a is separated from the lower sidewall portion 16b by point of maximum width S. The upper sidewall portion 16a preferably has a concave section 17 located in the upper sidewall portion 16a, near the shoulder area 18. Preferably, the concave section 17 is positioned between the shoulder 18 and sidewall 16a. The concave section 17 has a radius R_{X} in the range of 2 to 6 inches, more preferably 3-5 inches, and having a center point (origin) located outside of the tire. The concave section 17 may extend radially outward into the tread shoulder 18. Preferably, the concave section 17 is located at the intersection of the tread 14 and the upper sidewall 16a. The radius of the upper sidewall 16a has a radius RA. Preferably, R_{A} is greater than R_{X}. More preferably, R_{A} is two times greater than R_{X}.

Preferably, the lower sidewall portion 16b has a concave section 19. Preferably, the concave section 19 is located radially outward of the apex point 9 and radially inward of the point of maximum width S. The concave section 19 has a radius R_{Y} in the range of 2 to 6 inches, more preferably 2-4 inches, and a center point located outside of the tire. The radius of the lower sidewall 16b has a radius R_{B}. Preferably, R_{B} is greater than R_{Y}. Preferably, R_{B} is greater than R_{A}.

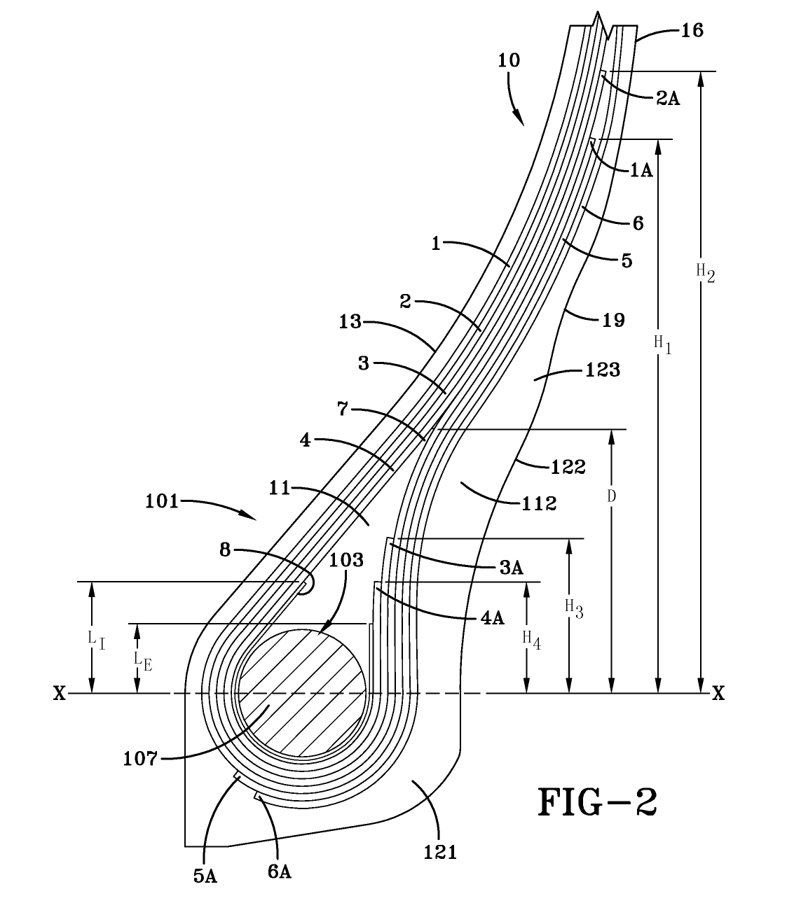

Furthermore, the tire 100 is reinforced with a carcass 10 toroidally extending from one of the bead portions 101 to the other bead portion 101. An air impervious inner liner 13 is located on the inner surface of the carcass 10. FIG. 2 schematically shows a partial cross section of an example tire bead structure 101 of a pneumatic tire in accordance with the present invention. The example tire shown is that of a standard size tire 50×20R22 with a load rating of 57,100 pounds and a pressure rating of 220 psi. Such a structure 101 may produce excellent durability and reduced chafing at the rim.

A carcass reinforcement 10 may be formed of four axially inner plies 1,2,3,4 and two axially outer plies 5, 6. The cross section of the bead 103 may be radially surmounted by a filler or first apex 111 of elastomeric mix having substantially the shape of a triangle in cross-section, the terminal end 7 of which extends radially from the axis of rotation of the tire a distance D from a reference line XX extending axially through the center of the bead wire. Preferably three of the axially inner carcass plies 1, 2, 3 extend down from the tread and are positioned axially inward and are wrapped around the bead core 103, forming turn-ups 1A, 2A, 3A, respectively. The axially innermost carcass plies 1,2 may have their respective turnup ends 1A,2A spaced radially from the line XX by the amount H₁,H2, which, for example, may range from 1.5 to 3 times the Apex height or distance D. Further, for example, the turnup ends 3A,4A of the inner plies 3 and 4 may also be located radially below the terminal end 7 of the first apex 111 at distances H₃ and H₄ respectively. Preferably turnup ends 1A, 2A are preferably located radially outward of the apex tip 7, and preferably higher than the chafer ending 123 of chafer 122. Preferably, the axially innermost ply 1 has the axially outermost turnup end 1A.

There is at least one carcass outer down ply 5 that encases the turn-ups 1A, 2A, 3A, 4A of the inner carcass plies 1, 2, 3, 4. The axially outer down ply 5 may, for example, be partially wound around the bead wire 103 over a portion or circular arc corresponding to an angle at the center of the circle circumscribed on the bead wire 103 equal to 180° or less so that the ends 5A of the outer ply 5 is situated radially inward of the reference line XX. Ply 6 as shown in FIG. 1 is optional. The carcass plies 1-6 may comprise reinforcements that make an angle between 70-90 degrees with respect with respect to the equatorial plane.

The angle of the inner plies is measured by the angle shown in FIG. 1 designated as PLA. The angle PLA is the angle between the axial direction (line X-X) and the axially outermost ply 4 of the axially inner plies 1-4, or the ply closest to the bead core. Preferably, PLA ranges from 40-55 as measured on a new tire that is not mounted on a rim and is not inflated.

A flipper 8 may separate the bead wire 103 from the carcass reinforcement 10 and be formed of radial textile cords identical to the carcass ply cords (or different cords). One terminal end of the flipper 8 may, for example, may extend a radial distance L_{I} of 18 mm from the line XX. The other terminal end of the flipper 8 may extend a radial distance L_{E} from the line XX equal to 10 mm.

The tire bead 103 may be supplemented by a reinforcement ply or outer first chafer 121 reinforced with radial textile cords. The rubber chafer 121 may permit a better distribution of the pressures between the tire and its service rim, as well as assuring protection of the carcass plies against injury upon mounting. The axially outer end of the first chafer 121 may be slightly above (about 20 mm) the reference line XX, while its axially inner end may be below the line XX.

An example tire with a bead structure as shown in FIG. 1 may include two annular bead portions/structures 101, a carcass 10 extending between the bead portions through two sidewall portions 101, and a tread portion (not shown). The carcass 10 may have at least one carcass ply 1 of parallel cords turned up about the bead portions 101, and a belt reinforcement layer (not shown) disposed radially outside the carcass 10 and radially inside the tread portion. Each annular bead portion 101 may include an annular bead core 103 having the carcass ply or plies 1-4 turned up around the bead core, a first apex 111 disposed adjacent and radially outward of the bead core, a second apex 112 disposed axially outward of the bead core and the carcass ply or plies, a first chafer 121 disposed adjacent the carcass ply or plies and axially outward of the bead core, and a second chafer 122 disposed adjacent and axially outward of the second apex.

The first apex 111 may be constructed of a material with a 300 percent modulus between 18-25 MPa. The second apex may be constructed of a material with a 300 percent modulus between 14-18 MPa. The first chafer 121 may be constructed of a material with a 300 percent modulus between 17-21 MPa. The second chafer 122 may be constructed of a material with a 300 percent modulus between 7-9 MPa. The axially outer end of the second chafer 122 may be about 60 mm above the line XX. The axially outer end of the second chafer 122 may thus cover the contact area between the tire and the wheel flange under a 200% rated loading condition. The sidewall portion 16 may be constructed of a material with a 300 percent modulus between 3 MPa and 8 MPa.

As stated above, a bead structure 101 in accordance with the present invention produces excellent durability and reduced chafing at the rim. This bead structure 101 thus enhances the performance of the pneumatic tire, even though the complexities of the structure and behavior of the pneumatic tire are such that no complete and satisfactory theory has been propounded.

The previous descriptive language is of the best presently contemplated mode or modes of carrying out the present invention. This description is made for the purpose of illustrating an example of general principles of the present invention and should not be interpreted as limiting the present invention. The scope of the invention is best determined by reference to the appended claims. The reference numerals as depicted in the schematic drawings are the same as those referred to in the specification. For purposes of this application, the various examples illustrated in the figures each use a same reference numeral for similar components. The examples structures may employ similar components with variations in location or quantity thereby giving rise to alternative constructions in accordance with the present invention.

What is claimed is:

1. A pneumatic tire comprising:
two annular bead portions having a bead core; a carcass extending between the bead portions through sidewall portions and a tread portion, each sidewall portion having an upper sidewall and a lower sidewall separated by the maximum width, wherein the lower sidewall further includes a first concave portion located between a radially outward end of the apex and the point of maximum width, when measured on unmounted, uninflated tire in a new condition.

2. The pneumatic tire of claim 1 wherein the pneumatic tire further comprises a second concave portion located in the upper sidewall.

3. The pneumatic tire of claim 1 wherein the first concave portion is located adjacent a radially outer end of the second apex.

4. The pneumatic tire of claim 2 wherein the second concave portion is located where the tread intersects the upper sidewall.

5. The pneumatic tire of claim 2 wherein the second concave portion is located axially outward of the belt package.

6. The pneumatic tire of claim 2 wherein the first concave portion and the second concave portion is separated by a convex portion.

7. The pneumatic tire of claim 1 wherein the carcass includes at least two plies which extend down from the tread and around the bead core forming at least one turnup.

8. The pneumatic tire of claim 1 wherein the angle of the axially inner plies is in the range of 40-55 degrees as measured with respect to axis XX, when measured in the unmounted, uninflated new condition.

9. The pneumatic tire of claim 1 wherein the angle of the axially inner plies is in the range of 40-50 degrees as measured with respect to axis XX, when measured in the unmounted, uninflated new condition.

10. The pneumatic tire of claim 1 wherein the angle of the axially inner plies is in the range of 40-45 degrees as measured with respect to axis XX, when measured in the unmounted, uninflated new condition.
